(19) United States
(12) Patent Application Publication
(10) Pub. No.: US 2006/0005774 A1
(43) Pub. Date: Jan. 12, 2006

(54) Behavior modifying food dish and method

(76) Inventor: Kathryn Anne Newman Bornhofen, Lakeville, MN (US)

Correspondence Address: Kathryn Newman Bornhofen, 1451 340th Street, Montgomery, MN, 56069, US

(21) Appl. No.: 10/746,831

(22) Filed: Dec. 24, 2003

(51) Int. Cl. A01K 5/01

(52) U.S. Cl. 119/61.5

(57) ABSTRACT

A device for increasing the time an animal takes to consume food from a food dish. The food dish of the present invention includes protrusions in the interior portion of the food dish. The protrusions create obstacles that the animal has to work around in order to remove food from the dish and thereby increases the time taken to consume food from the dish.

### FIELD OF THE INVENTION

This invention relates generally to devices for feeding animals, and more particularly relates to a device and method for feeding an animal. In use, the feeding device of the present invention may alter eating traits of the animal being fed, which may include inhibiting the rapid consumption of food.

### BACKGROUND OF THE INVENTION

Rapid consumption of food by dogs has been observed and associated with dogs that are socially competitive and/or exhibit a high prey drive. Dogs having these traits may typically consume 2 cups of hard dog food in less than 30 seconds. This rapid consumption of dog food may result in discomfort shown by roaching its back or walking stiff legged. After a rapid consumption of food dogs have also been observed belching or releasing air from the stomach, partial vomiting and regurgitation, or vomiting. Some have theorized that rapid consumption of food may also contribute to an adverse medical condition in dogs known as bloat (torsion). Increasing the time a dog takes to rapidly consume food decreases the rate a given volume enters a dog's throat and reduces the amount of discomfort exhibited. Aggressive or dominant behavioral traits in an animal may be exhibited in many situations including during its consumption of food. It has also been observed that dogs exhibiting possessive aggression related to their food may also consume their food rapidly.

In the past, dishes or bowls of various sizes and shapes have typically been used for feeding an animal. Generally, the dish has a bottom and a rim extending upward from the bottom to form a center cavity adapted for receiving and retaining food therein. The animal is able to easily scoop up excessive quantities of food. Additionally, gluttonous eaters typically attempt to swallow too much volume at too fast a rate. Thus, there is a need for a feeding dish that inhibits gluttonous eating traits of the animal. The present invention meets these and other needs that will become apparent from a review of the description of the present invention.

### SUMMARY OF THE INVENTION

The present invention provides a feeding device that tends to inhibit an animal's ability to scoop and swallow excessive volumes of food. This inhibition may decrease the rate a given volume of food is consumed. The feeding device of the present invention includes a base member that has a cavity defining an interior portion of the base. The cavity is adapted for receiving and retaining food within the cavity. At least two protrusions extend upward from an interior bottom portion of the cavity. When food is placed within the cavity, an animal attempting to remove the food from the dish must feed around the protrusions. Further, the protrusions tend to reduce the amount of food an animal is able to scoop out of the feeding device.

In an alternate preferred embodiment, three protrusions extending upward from the bottom portion of the cavity. Preferably, the protrusions are spaced symmetrically and centered within the interior portion of the base. The base may further include a stabilization lip and tabs or support members. The lip and support member reduce the likelihood that the base is tipped while the animal attempts to scoop food from the interior cavity.

These and other advantages of the present invention will become readily apparent to those skilled in the art from a review of the description of the preferred embodiment and/or when considered in conjunction with the claims and accompanying drawings in which like numerals in the several views refer to corresponding parts.

### DESCRIPTION OF THE DRAWINGS

FIG. 1 is front perspective view of the feeding dish of the present invention;

FIG. 2 is a partial sectional side elevational view of the feeding dish of the type shown in FIG. 1;

FIG. 3 is a top plan view of the feeding dish of the type shown in FIG. 1; and

FIG. 4 is a bottom plan view of the feeding dish of the type shown in FIG. 1.

### DETAILED DESCRIPTION

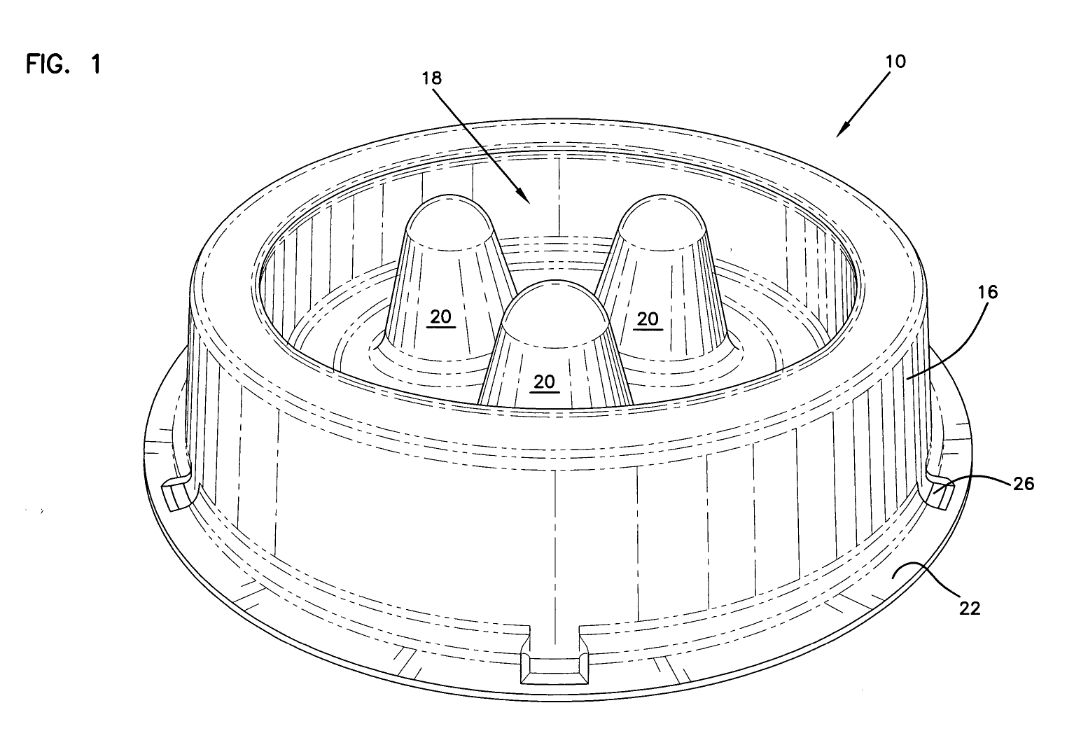

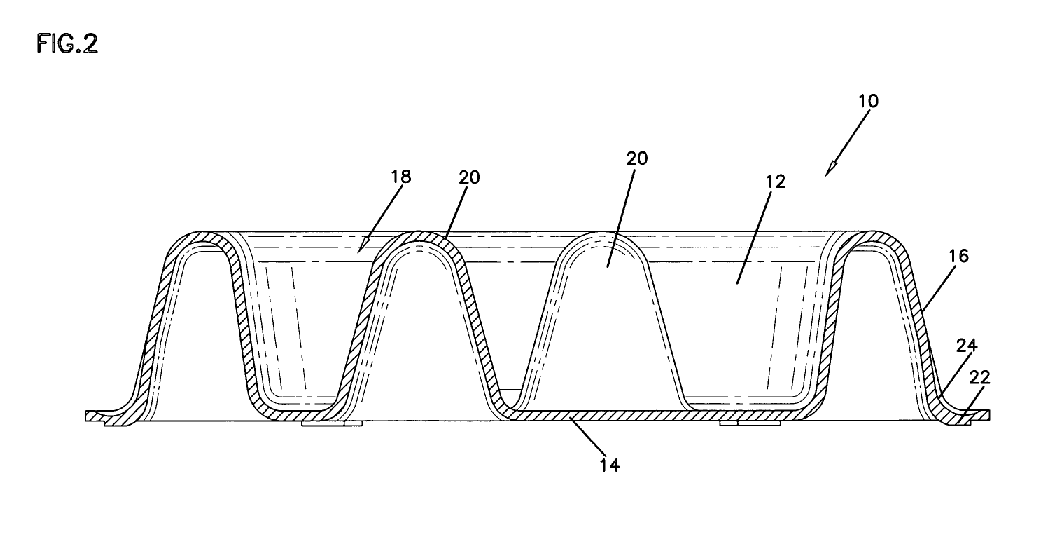

With reference to the Figures the device of the present invention will be described in greater detail. Referring first to FIGS. 1 and 2, the feeding dish 10 is shown. The feeding dish 10 generally includes a cylindrical base member 12 having a bottom 14 and sidewalls 16 forming a perimeter of the base member 12. A cavity 18 defines an interior portion of the base member 12. Protrusions 20 extend upward from the bottom 14 of the base member 12 within the cavity 18.

In the preferred embodiment three protrusions 20 are spaced an approximately equal distance from each other and centered within the interior portion of the base 12. The protrusions 20 are conically shaped to allow for access of the animals head and/or snout between the protrusions 20. Those skilled in the art will appreciate that the number, shapes, sizes or positioning of the protrusions 20 may be modified to inhibit the eating traits of the animal. For example, for narrow muzzled animals a greater number of protrusions may be desirable to decrease the distance between protrusions to slow the consumption of food. Likewise, for a wider muzzled animal the protrusions may need to be spaced further apart to allow access to the bottom of the cavity 18. Also, the height of the protrusions may be varied depending upon the length of the muzzle of the animal being fed. However, three conically shaped protrusions 20 symmetrically spaced within the cavity 18 is preferred.

In an alternative embodiment, the protrusions 20 may include adhering properties that allow for removal and/or replacement within the cavity 18 of the base 12. By providing protrusions that may be removed, the user may clean the protrusions 20 and the base 12 separately. Further, the user may selectively position the protrusions 20 within the cavity 18 as desired. Without any limitation intended, the adhering properties of the protrusion 20 to the base 12 may be mechanical, chemical or physical. For example, the base 12 may be metallic and a portion of the protrusion may have magnetic properties. When the protrusions 20 are placed within the cavity 18 of the base 12, the magnetic property of the protrusion cause the protrusions 20 to adhere to the metallic base 12. Additionally, the magnetic properties of the protrusions 20 keep the protrusions stationary within the cavity 12 while the animal eats around the protrusions 20. Those skilled in the art will further appreciate that the feeding dish 10 may be pliable and the protrusions moveable within the cavity 18 formed in the dish 10 to provide for a partially collapsible dish.

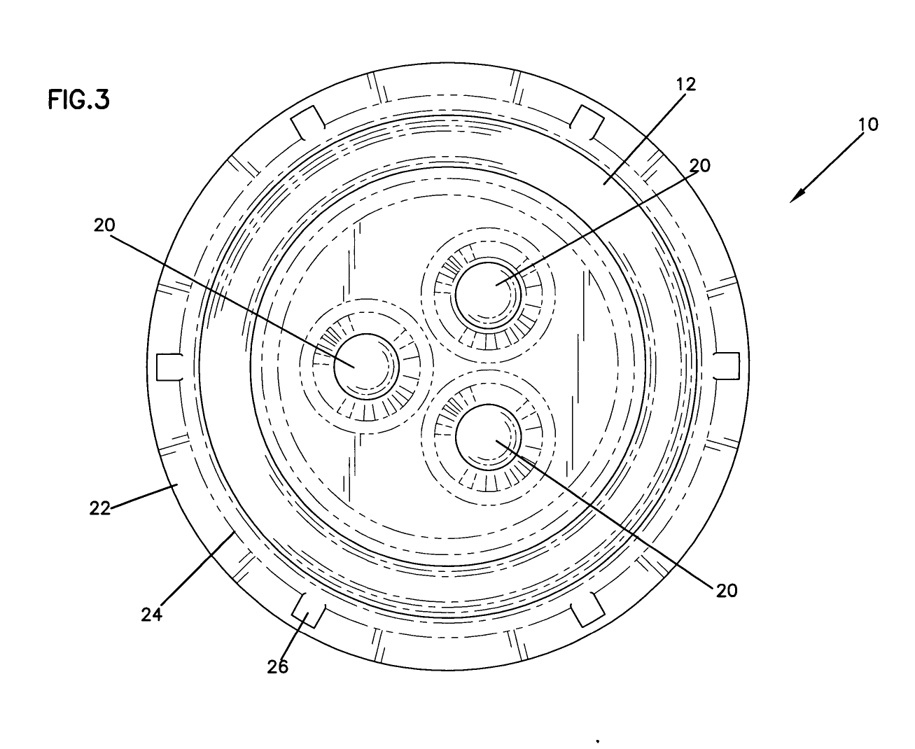

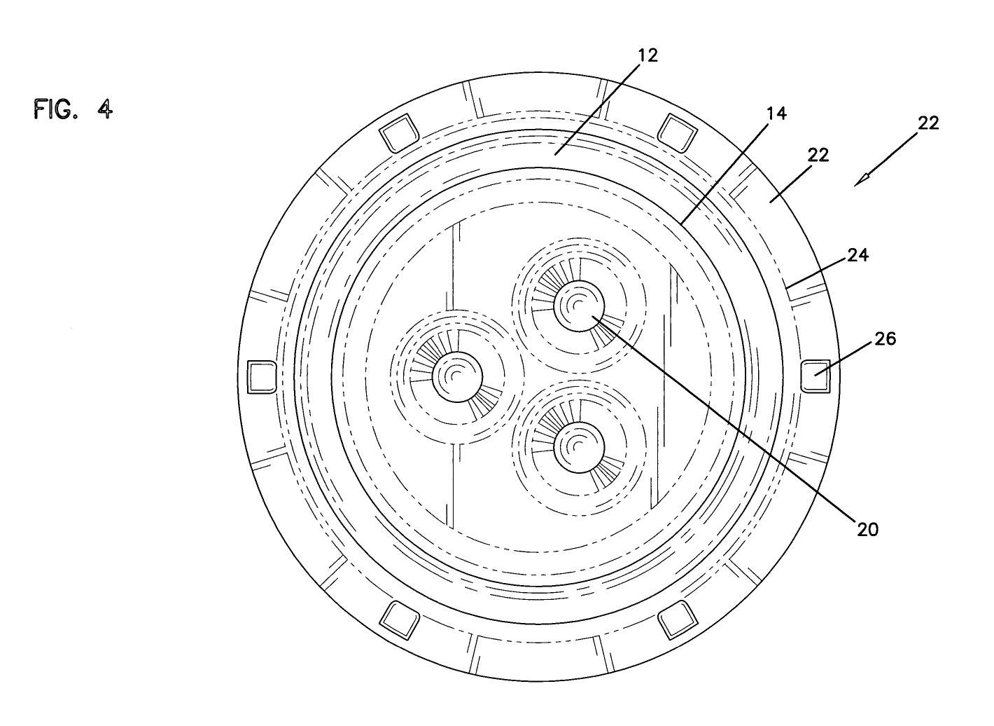

Referring now to FIGS. 3 and 4, the base member 12 is shown further including a lip 22 extending outwardly from an outer bottom portion 24 of the base member 12. The lip 22 includes support members or tabs 26 extending from the lip. The tabs 26 provide for stability of the lip 22 when placed on uneven surfaces and also provides a gripping function for the lip 22.

Having described the construction of an embodiment of the present invention, the mode of use will next be presented. The user desiring to feed an animal places a layer of food in the feeding dish 10. When the animal is allowed to feed from the dish 10, the animal has to work around the protrusions 20 requiring more licking than gulping or scooping to remove the food from the dish 10. In this manner the rate the animal is able to remove food from the feeding device is reduced and likewise the volume or amount of food removed from the feeding device at any given attempt is reduced. The reduction in rate and volume has an overall slowing affect and reduces the ability of the animal to feed rapidly.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A device for modifying the behavior of an animal, the device comprising:
a base member having a cavity defining an interior portion of said base member; and
at least two protrusions positioned within the interior portion of said base and extending upward from a bottom portion of the base within the cavity, wherein said protrusions are spaced an approximately equal distance from each other and centered within the interior portion of said base.

2. The device of claim 1, including at least three protrusions extending upward from the bottom portion of the cavity.

3. (canceled)

4. The device of claim 1, wherein said base member further includes a lip extending outwardly from an outer bottom portion of said base member.

5. The device of claim 4, wherein said lip includes support members extending therefrom.

6. The device of claim 1, wherein said base member is generally cylindrical.

7. The device of claim 1, wherein said protrusions are conically shaped.

8. The device of claim 2, wherein said protrusions are conically shaped.

9. A device for modifying the behavior of an animal, the device comprising:
a base member having a cavity defining an interior portion of said base member; and
at least three protrusions centered within the interior portion of said base and extending upward from a bottom portion of the cavity.

10. The device of claim 9, wherein said protrusions are spaced an approximately equal distance from each other and centered within the interior portion of said base.

11. The device of claim 9, wherein said base member further includes a lip extending outwardly from an outer bottom portion of said base member.

12. The device of claim 11, wherein said lip includes support members extending therefrom.

13. The device of claim 9, wherein said base member is generally cylindrical.

14. The device of claim 9, wherein said protrusions are conically shaped.

15. A device for modifying the behavior of an animal, the device comprising:
a base member having a cavity defining an interior portion of said base member; and
at least three protrusions positioned within the interior portion of said base and extending upward from a bottom portion of the cavity, wherein said protrusions are spaced an approximately equal distance from each other and centered within the interior portion of said base.

16. The device of claim 15, wherein said base member further includes a lip extending outwardly from an outer bottom portion of said base member.

17. The device of claim 16, wherein said lip includes support members extending therefrom.

18. The device of claim 15, wherein said base member is generally cylindrical.

19. The device of claim 15, wherein said protrusions are conically shaped.
